(19) United States
(12) Patent Application Publication
(10) Pub. No.: US 2004/0071385 A1
(43) Pub. Date: Apr. 15, 2004

(54) PCB incorporating integral optical layers

(76) Inventor: Bruce W. Lee, Chippewa Fall, WI (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/271,607

(22) Filed: Oct. 15, 2002

(51) Int. Cl. G02B 6/12

(52) U.S. Cl. 385/14

(57) ABSTRACT

Printed circuit/wiring boards having optical wavguides integrated into conductive layers. More specifically, copper layers used to form pads and traces are also used to form optical waveguide mirrors and other structures, preferably by removing copper from areas in which waveguides are to be formed while leaving sufficient copper in appropriate locations to be used in waveguide structures.

### FIELD OF THE INVENTION

The field of the invention is printed circuit/wiring boards with optical waveguides.

### BACKGROUND OF THE INVENTION

An optical board, as the term is used herein, is a board (possibly a printed circuit/wiring board) or other support structure that comprises one or more optical waveguides. An optical waveguide is a structure that “guides” a light wave by constraining it to travel along a certain desired path. A waveguide traps light by surrounding a guiding region, called the core, with a material called the cladding, where the core is made from a transparent or translucent material with higher index of refraction than the cladding.

In some instances, the optical waveguides of an optical board will include one or more surface waveguides, such waveguides frequently comprising an optical resin deposited on a substrate to form a ridge waveguide. The optical waveguides of an optical board will in some instances include internal waveguides, i.e. waveguides imbedded in an external or internal layer of the optical board. In some instances an optical board may comprise a plurality of parallel traces. In some instances, an optical board may be a printed wiring/circuit board that includes both optical waveguides and electrical conductors.

### SUMMARY OF THE INVENTION

The present invention is directed to printed circuit/wiring boards having optical waveguides integrated into conductive layers. More specifically, copper or other conductive layers used to form pads and traces are also used to form optical waveguide mirrors and other structures, preferably by removing copper from areas in which waveguides are to be formed while leaving sufficient copper in appropriate locations to be used in waveguide structures. Such waveguide structures are particularly well adapted for use with non-polymeric waveguide cores, in particular cores formed from glass materials such as soda lime and borosilicate glass formulations. However, less preferred embodiments may utilize other glass formulations.

Pads and traces, as the terms are used herein, are well known in the art and typically are conductive structures formed for the purpose of conducting electricity. Pads are typically used in forming connections with other layers, boards, components or other devices, and provide a relatively large conductive area to which an electrical connection can be made, the size of the pad facilitating forming a connection. Traces provide a means of interconnection on a layer, are generally longer and narrower than pads, and generally function as interconnecting “wires”. Formation of pads and traces is typically accomplished by way of build-up or removal processes well known in the art.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a cutaway perspective view of an optical board embodying the invention.

FIG. 2 is a cutaway perspective view of a copper clad laminate that could be used to form the optical board of FIG. 1.

FIG. 3 is a cutaway side view of a waveguide embodying the invention.

FIG. 4 is a cutaway end view of the waveguide of FIG. 3.

FIG. 5 is a perspective view of optical waveguide structure 120 of FIG. 1.

### DETAILED DESCRIPTION

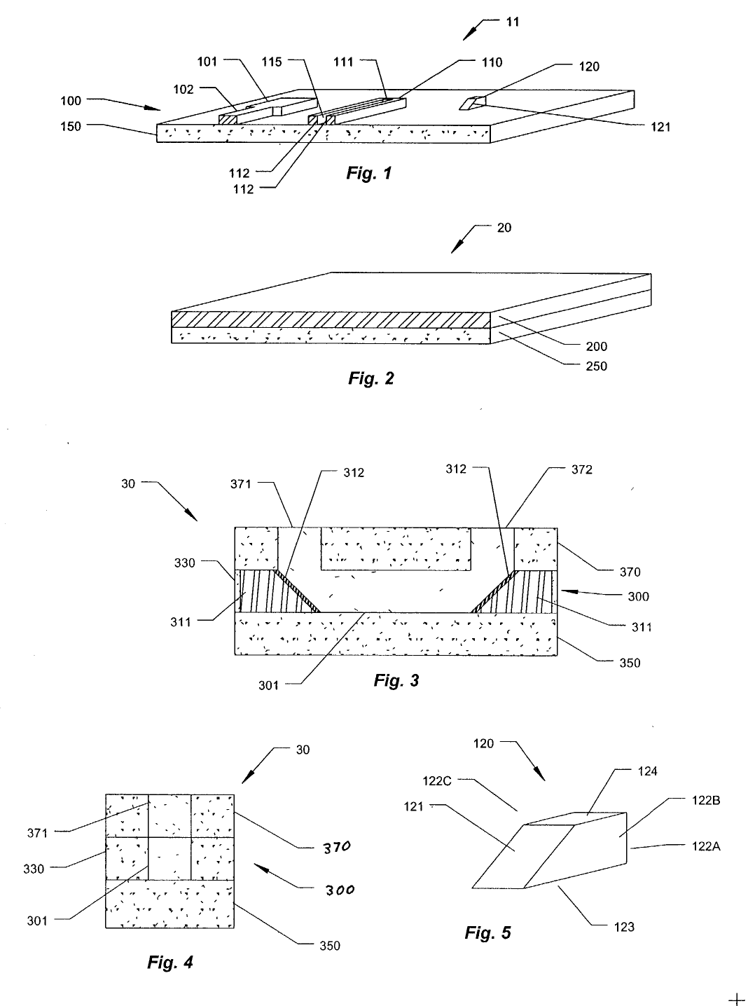

Referring to FIG. 1, a printed wiring board (PWB) 11 comprises a substrate layer 150, and at least one conductive layer 100 wherein the conductive layer comprises at least one pad 101 or trace 102, and at least one optical waveguide structure (110 and 120). As the optical waveguide structures 110 and 120 are part of the same conductive layer as conductive components such as pad 101 and trace 102, and since the finished waveguides will be part of the same layer, board 11 can be described as having an integral optical waveguide.

As used herein, the phrase “conductive layer comprises” is intended to indicate that the process used to form any pads and traces is also used, at least in part, to form any optical waveguide structures. Thus, if any pads and traces are formed by etching material from a solid copper layer, formation of at least one optical waveguide structure will be formed as part of the same etching process. If any pads and traces are formed by build-up processes, formation of at least one optical waveguide structure will also be formed as part of the same build-up process. However, if pads and traces are formed by both build-up and removal processes, the formation of at least one optical waveguide structure need only involve a build-up or a removal process.

One method of forming a PWB having integral optical waveguides includes providing a substrate coated with copper or other conductive material forming a conductive layer, etching the conductive layer to remove unwanted portions but leaving copper for any desired optical waveguide structures as well as electrical components such as pads and traces, and subjecting the optical waveguide structures to milling, plating or other processing steps. FIG. 2 illustrates a copper coated substrate 20 comprising substrate/dielectric layer 250 and copper/conductive layer 200 that is particularly suited for use with material removal methods in which layer 200 is formed into desired optical waveguide structures and electrical components. It is contemplated that build up methods such as plating can be used to supplement and/or replace etching/removal methods to produce a substrate having the desired conductive structures. Many if not all methods suitable for forming pads and traces can be applied to forming waveguide structures. It is contemplated that most methods will involve imaging, etching, and/or plating.

Structure 120 of FIGS. 1 and 5 is a base supporting an angled surface positioned to redirect light passing through the waveguide into or out of the waveguide. Structure 120 comprises angled surface 121 and side surfaces 122A-122C. Side surfaces 122 were formed via etching at the same time that pad 101 and trace 102 were formed. Angled surface 121 is preferably formed after chemical etching, laser ablation, fluid cutting, or mechanical machining by removing portions of top surface 124 and the body of structure 120. Surface 121 is preferably angled forty-five degrees from the plane of conductive layer 100.

FIG. 3 depicts an embodiment 30 of a waveguide formed in a conductive layer 300 and comprising core 301, angled mirrored surfaces 312, and angled support structures 311. The waveguide shown is supported by substrate 350, has conductive layer 300 filled in by dielectric 330, and is covered by dielectric layer 370. Dielectric layer 370 comprises two optical vias 371 and 372 to permit light to pass into and out of the waveguide. Core 301 comprises a non-polymeric material in solid, liquid or gas form. Preferred embodiments will utilize a solid core formed from glass materials such as soda lime and borosilicate glass formulations. However, less preferred embodiments may utilize other glass formulations. Dielectric layer 370 perferably comprises a lower refractive index than core 301 such that a cladding layer surrounding core 301 is not necessary. However, less preferred embodiments may include such a cladding layer.

FIG. 4 provides a side view of the waveguide of FIG. 3. The phrase “in a conductive layer” indicates that the core of the waveguide lies in the same “plane” as conductively layer, and was likely formed by filling or inserting the core into open areas of conductive layer 300.

Although any process which results in the desired properties for waveguide structures may be used, it is preferred that laser ablation or micro machining be used. After being formed into the desired shape, subsequent processing may include plating one or more surfaces of the structure. In this instance, angled surfaces of structures 311 are plated with layer 312 so that they better reflect light passing through the waveguide. Although the characteristics of plating layer 312 will likely vary between embodiments, it is currently preferred that layer 312 be comprised of silver (Ag) based metallic coating, and be formed by direct deposition or electroplating.

As can be seen from the figures, the waveguide of FIGS. 3 and 4 is shaped so as to have rectangular cross-sectional shape in a first plane and a trapezoidal cross sectional shape in a second plane perpendicular to the first plane.

Referring back to FIG. 1, optical waveguide structure 110 comprises side walls 112 as well as angled surface 111. It is contemplated that such a structure may facilitate the formation of the core of a waveguide in channel 115 with sides 112 acting as cladding for the waveguide.

Sides 112 (and surface 111) may comprising a reflecting coating layer, or sides 112 may comprise a dielectric material (such as 330 in FIG. 3) used to fill in any open spaces in layer 100, and/or to bond layers 100 and 150 to another layer or set of layers. If coated, it is contemplated that electroless plating methods may be used to coat sides 112. If a structure such as structure 120 is used, sides similar to sides 112 may be added either before or after forming the core of the waveguide. Such sides may comprises a dielectric material used to fill in spaces in layer 100 and/or to bond layers 100 and 150 to adjoining layers, and may also comprise a reflective coating formed by a process such as electroless plating.

Substrate layers 150, 250, and 350 can comprise a single layer or multiple layers, and can be formed from one material or a variety of materials. In preferred embodiments the substrate will be a typical PWB substrate comprising multiple conductive and dielectric layers, plated through holes and vias, and possibly comprising embedded electrical components such as resistors, capacitors, and inductors. The actual structure and method of formation of a substrate to be used is not critical and any suitable structure and or method of formation may be used.

Conductive layers 100, 200 and 300 can be formed from any conductive material or materials. However copper is currently preferred. In many instances the conductive layer will be formed from a plurality of layers. As an example, it may be formed by sputtering a first layer onto a substrate and subsequently plating the sputtered layer to increase its thickness. In other instances it may comprise a metal foil bonded to a substrate. The actual structure and method of formation of a conductive layer prior to formation of the waveguide and electrical structures is not critical and any suitable structure and or method of formation may be used.

The incorporation of optical waveguides into a PCB is an enabling technology that allows the use of optical components to be linked. The use of optical components and waveguides primary advantages are that it allows significant increases in data bandwith when compared to the capability of copper traces that are typical in todays electronic assemblies. Today, optical data transfer is limited to fibers and some connector technologies but continues to expand down through the entire architecture of electronic devices. Ultimately, there will be optical interconnectivity from the component level up through the entire architecture of a system. The integral waveguide in a PCB is one link in an all optical system.

Thus, specific embodiments of and methods relating to of optical waveguides have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A printed wiring board comprising at least one conductive layer wherein the conductive layer comprises at least one pad or trace, and at least one optical waveguide structure.

2. The board of claim 1 wherein the optical waveguide structure comprises at least one etched surface.

3. The board of claim 1 wherein the conductive layer is formed by a build-up process.

4. The board of claim 2 wherein the optical waveguide structure is a base supporting an angled surface positioned to redirect light passing through the waveguide, and the at least one etched surface is not the angled surface.

5. The board of claim 1 wherein the conductive layer is planar, and the optical waveguide structure comprises a surface angled forty five degrees from the plane of the layer.

6. The board of claim 5 wherein the angled surface is plated with at least one of the following: silver, gold, and aluminum.

7. The board of claim 1 wherein the waveguide structure is a mirror support positioned at the end of a segment of the waveguide, where the waveguide is shaped so as to have rectangular cross-sectional shape in a first plane and a trapezoidal cross sectional shape in a second plane perpendicular to the first plane.

8. The board of claim 7 wherein the at least one pad or trace, and the mirror support all comprise copper.

9. The board of claim 8 wherein the mirror support comprises an angled surface plated with at least one of the following: silver, gold, and aluminum.

10. The board of claim 9 wherein the mirror support is coupled to a glass core.

11. The board of claim 10 wherein the glass core is soda lime glass or borosilicate glass.

12. A method of forming a printed wiring board comprising:
providing a substrate having an exposed conductive layer; and
forming the conductive layer into a pattern having at least one pad or trace, and at least one optical waveguide structure.

13. The method of claim 12 wherein the forming the conductive layer includes one or more of the following processing steps: imaging, etching, and plating.

14. The method of claim 13 wherein the conductive layer is planar, and the waveguide structure comprises a surface angled forty five degrees from the plane of the layer.

15. The method of claim 13 wherein forming the conductive layer into a pattern comprises forming an elongated open volume bordered by the layer, the volume having a rectangular cross-sectional shape in a first plane and a trapezoidal cross sectional shape in a second plane perpendicular to the first plane.

16. The method of claim 15 further comprising filling the elongated open volume with glass to form a glass core.

17. The method of claim 16 wherein the glass is soda lime glass or borosilicate glass.
